(19) United States
(12) Patent Application Publication
(10) Pub. No.: US 2022/0237452 A1
(43) Pub. Date: Jul. 28, 2022

(54) NEURAL NETWORK DEVICE, INFORMATION PROCESSING DEVICE, AND COMPUTER PROGRAM PRODUCT

(71) Applicant: KABUSHIKI KAISHA TOSHIBA, Tokyo (JP)

(72) Inventors: Takao MARUKAME, Chuo Tokyo (JP); Koichi MIZUSHIMA, Kamakura Kanagawa (JP); Kumiko NOMURA, Shinagawa Tokyo (JP); Yoshifumi NISHI, Yokohama Kanagawa (JP)

(73) Assignee: KABUSHIKI KAISHA TOSHIBA, Tokyo (JP)

(21) Appl. No.: 17/458,013

(22) Filed: Aug. 26, 2021

(30) Foreign Application Priority Data
Jan. 27, 2021 (JP) 2021-011226

(51) Int. Cl. G06N 3/08

(52) U.S. Cl. CPC G06N 3/08

(57) ABSTRACT

A neural network device according to an embodiment includes an arithmetic circuit, a learning control circuit, and a bias reset circuit. The arithmetic circuit executes arithmetic processing according to a neural network using a plurality of weights each represented by a value of a first resolution and a plurality of biases each represented by a value in ternary. At the time of learning of the neural network, the learning control circuit repeats a learning process of updating each of the plurality of weights and each of the plurality of biases a plurality of times based on a result of the arithmetic processing according to the neural network performed by the arithmetic circuit. In each learning process, the bias reset circuit resets a bias randomly selected with a preset first probability among the plurality of biases to a median in the ternary.

### CROSS-REFERENCE TO RELATED APPLICATIONS

This application is based upon and claims the benefit of priority from Japanese Patent Application No. 2021-011226, filed on Jan. 27, 2021; the entire contents of which are incorporated herein by reference.

### FIELD

Embodiments described herein relate generally to a neural network device, an information processing device, and a computer program product.

### BACKGROUND

In recent years, a neural network device implemented by hardware has been studied. Each of units included in such a neural network device implemented by hardware is implemented by an electric circuit. The units implemented by the electric circuit execute addition of a value by product-sum operation (multiply-accumulation) and a bias. That is, each unit implemented by an electric circuit multiplies, by a weight, each of a plurality of input values received from a unit in the previous stage, and adds the plurality of multiplied values to which the weights have been multiplied and the bias.

In addition, the neural network device implemented by hardware can use a weight represented by a value in binary. This enables the neural network device to execute inference at high speed.

However, even when the weight to be used for the inference can be in binary, the weight used in a learning process needs to be updated by a minute amount in order to heighten precision. As such, the weight used in the learning process is preferably continuous-valued (multi-valued). For example, it is considered that the weight at the time of learning needs to have a precision of about 1000 gradations, for example, about 10 bits.

In addition, the neural network learning device calculates an output value by performing forward processing on input data to be learned. Subsequently, the learning device calculates an error value between the output value calculated by the forward processing and a target value, performs backward processing on the error value, and calculates an update value of each of the plurality of weights and each of the plurality of biases. Subsequently, the learning device adds the corresponding update value to each of the plurality of weights and each of the plurality of biases. The learning device repeatedly executes such a learning process for a plurality of pieces of input data.

The learning device gives an error between the output value and the target value to an evaluation function and evaluates the magnitude of the error for the plurality of pieces of input data as a whole. The neural network device is characterized in that the smaller the error, the higher the correct answer rate that is achieved in inference. A state in which the error is zero or close to zero is referred to as convergence of learning. The learning device repeatedly executes the learning process until the learning converges.

Meanwhile, it is preferable that the learning device achieves convergence of learning in a shorter time. That is, it is preferable that the learning device executes the learning process so that the learning converges with less learning times.

### BRIEF DESCRIPTION OF THE DRAWINGS

FIG. 1 is a diagram illustrating a configuration of a neural network device according to an embodiment;

FIG. 2 is diagram illustrating one layer of a neural network;

FIG. 3 is a diagram illustrating a product-sum operation performed by a product-sum operation circuit;

FIG. 4 is a flowchart illustrating a processing flow at the time of learning;

FIG. 5 is a diagram illustrating a first example of an integral value of an error value with respect to the number of times of a learning process;

FIG. 6 is a diagram illustrating a second example of an integral value of an error value with respect to the number of times of the learning process;

FIG. 7 is a diagram illustrating a first example of the number of times of learning until convergence with respect to the probability used in resetting;

FIG. 8 is a diagram illustrating a second example of the number of times of learning until convergence with respect to the probability used in resetting;

FIG. 9 is a diagram illustrating a third example of the number of times of learning until convergence with respect to the probability used in resetting;

FIG. 10 is a hardware configuration diagram of product-sum operation circuit;

FIG. 11 is an explanatory diagram of an arithmetic operation when xᵢ=+1 and wᵢ=+1;

FIG. 12 is an explanatory diagram of an arithmetic operation when xᵢ=−1 and wᵢ=+1;

FIG. 13 is an explanatory diagram of an arithmetic operation when xᵢ=+1 and wᵢ=−1;

FIG. 14 is an explanatory diagram of an arithmetic operation when xᵢ=−1 and wᵢ=−1;

FIG. 15 is an explanatory diagram of an arithmetic operation when b=0;

FIG. 16 is an explanatory diagram of operation of a comparator; and

FIG. 17 is a diagram illustrating an example of a hardware configuration of a computer according to an embodiment.

### DETAILED DESCRIPTION

A neural network device according to an embodiment includes an arithmetic circuit, a learning control circuit, and a bias reset circuit. The arithmetic circuit executes arithmetic processing according to a neural network using a plurality of weights each represented by a value of a first resolution and a plurality of biases each represented by a value in ternary. The learning control circuit repeats a learning process of updating each of the plurality of weights and each of the plurality of biases a plurality of times based on a result of the arithmetic processing according to the neural network performed by the arithmetic circuit at the time of learning of the neural network. The bias reset circuit resets a bias randomly selected with a preset first probability among the plurality of biases to a median in the ternary in each of the learning processes. An objective of embodiments herein is to provide a neural network device, an information processing device, and a computer program product capable of achieving high-precision learning with less learning times. Hereinafter, a neural network device 10 according to an embodiment will be described with reference to the drawings.

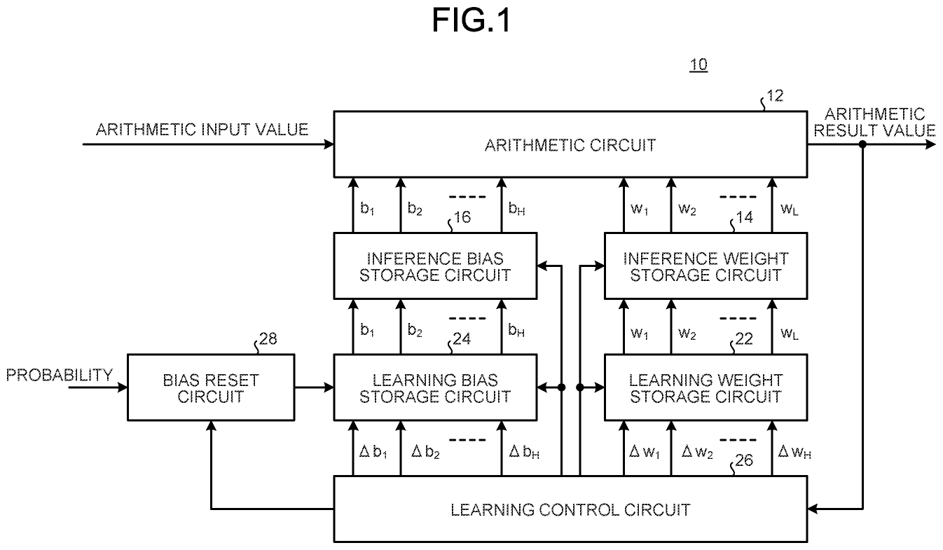

FIG. 1 is a diagram illustrating a configuration of the neural network device 10 according to the embodiment. The neural network device 10 includes an arithmetic circuit 12, an inference weight storage circuit 14, an inference bias storage circuit 16, a learning weight storage circuit 22, a learning bias storage circuit 24, a learning control circuit 26, and a bias reset circuit 28.

The arithmetic circuit 12 executes arithmetic processing according to a neural network using a plurality of weights and a plurality of biases. The arithmetic circuit 12 receives a plurality of arithmetic input values to be subjected to arithmetic operation, executes arithmetic processing on the received plurality of arithmetic input values, and outputs an arithmetic result value. The arithmetic circuit 12 may output a plurality of arithmetic result values. In the present embodiment, the arithmetic circuit 12 is implemented by an electric circuit including an analog circuit.

The inference weight storage circuit 14 stores a plurality of weights used in arithmetic processing according to the neural network performed by the arithmetic circuit 12. The inference weight storage circuit 14 stores L weights (w₁, . . . , w_{L}) (L is an integer of 2 or greater), for example. Each of the plurality of weights is represented by a value of the first resolution. The first resolution is a resolution represented by an integer of 2 or greater. In the present embodiment, each of the plurality of weights is represented in binary (by a binary value). For example, in the present embodiment, each of the plurality of weights has a value of −1 or +1. This enables the arithmetic circuit 12 to execute arithmetic processing according to the neural network at high speed by the analog circuit by using a plurality of weights each being represented in binary.

The inference bias storage circuit 16 stores a plurality of biases used in arithmetic processing according to the neural network performed by the arithmetic circuit 12. The inference bias storage circuit 16 stores H biases (b₁, . . . , b_{H}) (H is an integer of 2 or greater), for example. Each of the plurality of biases is represented in ternary (by a ternary value). In the present embodiment, each of the plurality of biases has a value of −1, 0, or +1. This enables the arithmetic circuit 12 to execute arithmetic processing according to the neural network at high speed by the analog circuit by using a plurality of biases each of which is represented in ternary.

Note that the smallest value in the ternary (−1 in the present embodiment) represents the same level as the smaller value in the binary (−1 in the present embodiment). In addition, the largest value (+1 in the present embodiment) in ternary represents the same level as the larger value (+1 in the present embodiment) in the binary. The median (0 in the present embodiment) in the ternary represents an intermediate value between the smaller value (−1 in the present embodiment) and the larger value (+1 in the present embodiment) in the binary, or represents that the value in the binary is invalid.

The learning weight storage circuit 22 stores a plurality of learning weights used in the learning process of the neural network. The plurality of learning weights corresponds one-to-one to the plurality of weights. Each of the plurality of learning weights is represented by a second resolution higher than the first resolution. The learning weight storage circuit 22 stores L learning weights (w₁, . . . , w_{L}) that correspond one-to-one to L weights, for example. Each of the plurality of learning weights stored in the learning weight storage circuit 22 is represented by a signed 10-bit precision, for example.

The learning bias storage circuit 24 stores a plurality of learning biases used in the learning process of the neural network. The plurality of learning biases corresponds one-to-one to the plurality of biases. Each of the plurality of learning biases is represented by a third resolution higher than the ternary. The third resolution may be the same as the second resolution. The learning bias storage circuit 24 stores H learning biases (b₁, . . . , b_{H}) corresponding one-to-one to the H biases, for example. Each of the plurality of learning biases stored in the learning bias storage circuit 24 is represented by a signed 10-bit precision, for example.

The learning control circuit 26 controls processing at the time of learning of the neural network. At the start of learning, the learning control circuit 26 initializes the plurality of learning weights stored in the learning weight storage circuit 22 and the plurality of learning biases stored in the learning bias storage circuit 24.

In addition, the learning control circuit 26 controls the learning weight storage circuit 22 to transfer the plurality of weights obtained by binarizing each of the plurality of stored learning weights to the inference weight storage circuit 14. This enables the inference weight storage circuit 14 to store the plurality of weights obtained by binarizing each of the plurality of learning weights. Furthermore, the learning control circuit 26 controls the learning bias storage circuit 24 to transfer a plurality of biases obtained by ternarizing each of the plurality of stored learning biases to the inference bias storage circuit 16. This enables the inference bias storage circuit 16 to store a plurality of biases obtained by ternarizing each of the plurality of learning biases.

In addition, the learning control circuit 26 repeats the learning process of updating each of the plurality of weights and each of the plurality of biases a plurality of times based on an operation result of arithmetic processing according to the neural network performed by the arithmetic circuit 12.

In each of the learning processes, the learning control circuit 26 calculates error information between an operation result of arithmetic processing according to a neural network using a plurality of weights and a plurality of biases and supervisory information. Furthermore, the learning control circuit 26 calculates an error value for each of the plurality of weights and each of the plurality of biases by applying back propagation of the calculated error information to the neural network. The error value of each of the plurality of weights is represented by the second resolution (for example, signed 10 bits) being the resolution of the learning weight. Furthermore, the error value of each of the plurality of biases is represented by the third resolution (for example, signed 10 bits) being the resolution of the learning bias.

Subsequently, the learning control circuit 26 adds a corresponding error value to each of the plurality of learning weights stored in the learning weight storage circuit 22. In addition, the learning control circuit 26 adds a corresponding error value to each of the plurality of learning biases stored in the learning bias storage circuit 24. The learning control circuit 26 then controls the inference weight storage circuit 14 to store a plurality of weights obtained by binarizing each of the plurality of learning weights stored in the learning weight storage circuit 22. In addition, the learning control circuit 26 controls the inference bias storage circuit 16 to store a plurality of biases obtained by ternarizing each of the plurality of learning biases stored in the learning bias storage circuit 24. Subsequently, the learning control circuit 26 executes the next learning process using a new plurality of weights and a new plurality of biases.

The learning control circuit 26 repeats the above learning process until convergence of the learning. This enables the learning control circuit 26 to increase or decrease each of the plurality of learning weights and a plurality of learning biases by a minute amount, making it possible to train the neural network with high precision.

In each of the learning processes repeated a plurality of times, the bias reset circuit 28 resets a bias selected with a preset first probability among the plurality of biases, to the median in the ternary. In the present embodiment, the bias reset circuit 28 resets the selected bias among the plurality of biases to zero (0).

For example, in each of the learning processes, before transferring the plurality of ternarized biases from the learning bias storage circuit 24 to the inference bias storage circuit 16, the bias reset circuit 28 resets the learning bias after the error value is added to a value to be converted into the median in the ternary, for the bias selected with the first probability among the plurality of biases. In the present embodiment, the bias reset circuit 28 resets the learning bias corresponding to the selected bias to a value to be converted to 0 when represented in ternary.

Note that the bias reset circuit 28 resets the plurality of biases with equal probability. As long as a plurality of biases can be reset with equal probability, it is allowable that the bias reset circuit 28 resets two or more biases simultaneously or does not reset any bias in each of the learning processes.

The first probability is a minute probability such as 0.01% to 0.1%, for example. For example, in a case where the first probability is 0.1%, the bias reset circuit 28 may randomly reset each of the plurality of biases to 0 with a probability of once out of 1000 times. Furthermore, in a case where the first probability is 0.1% and the neural network uses 1000 biases, the bias reset circuit 28 may randomly select a bias with a probability of 1 out of 1000 biases and may reset the selected bias to 0 in each of the learning processes. Furthermore, in a case where the first probability is 0.1% and the neural network uses 100 biases, the bias reset circuit 28 may randomly select a bias at a probability of one in 10 times of learning processes and may reset the selected bias to 0.

By executing such processing at the time of learning, the bias reset circuit 28 can reduce the learning times until the learning converges.

Subsequently, at the time of inference, the arithmetic circuit 12 executes arithmetic processing according to a neural network using a plurality of weights each represented in binary and a plurality of biases each represented in ternary, which are obtained after completion of the learning.

With this operation, the arithmetic circuit 12 can execute, at the time of inference, arithmetic processing with high accuracy at high speed.

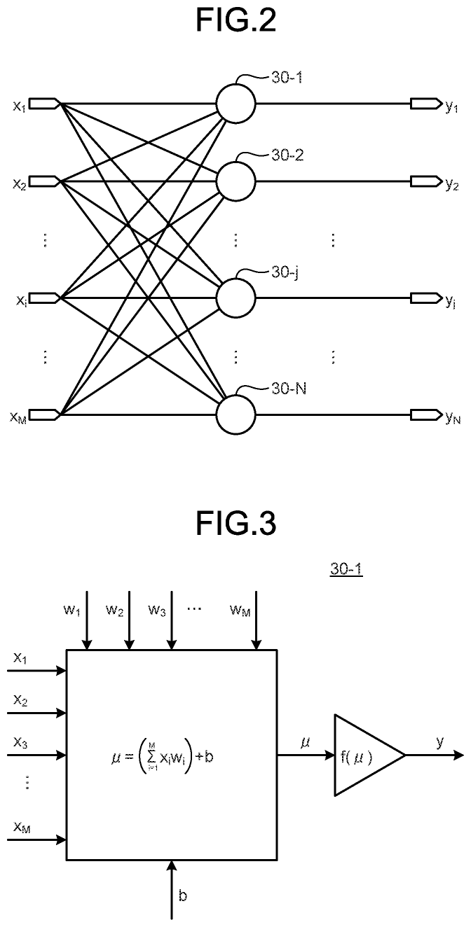

FIG. 2 is diagram illustrating one layer of a neural network. The neural network includes, for example, one or more layers as illustrated in FIG. 2. The arithmetic circuit 12 includes a circuit that executes an arithmetic operation corresponding to a layer as illustrated in FIG. 2.

The layer illustrated in FIG. 2 receives M input values (x₁ to x_{M}) (M is an integer of 2 or greater) and outputs N output values (y₁ to y_{N}) (N is an integer of 2 or greater). In order to execute layer operations as illustrated in FIG. 2, the arithmetic circuit 12 includes N product-sum operation circuits 30 (30-1 to 30-N) corresponding to N output values (y₁ to y_{N}), for example. The j-th product-sum operation circuit 30-j (j is an arbitrary integer from 1 to N) of the N product-sum operation circuits 30 corresponds to the j-th output value (yⱼ). Each of the N product-sum operation circuits 30 receives M input values (x₁ to x_{M}).

FIG. 3 is a diagram illustrating a product-sum operation performed by the first product-sum operation circuit 30-1. The arithmetic circuit 12 includes a plurality of product-sum operation circuits 30. Each of the plurality of product-sum operation circuits 30 executes one of product-sum operation processes included in the neural network.

M input values (x₁, x₂, . . . , x_{M}) are input to the first product-sum operation circuit 30-1 among the plurality of product-sum operation circuits 30. Moreover, M weights (w₁, w₂, . . . , w_{M}) corresponding to M input values among the plurality of weights stored in the inference weight storage circuit 14 are set in the first product-sum operation circuit 30-1. In the first product-sum operation circuit 30-1, a predetermined number of biases (b) corresponding to the first product-sum operation circuit 30-1 among the plurality of biases stored in the inference bias storage circuit 16 are set. Although the example of FIG. 3 is a case where one bias is set in the first product-sum operation circuit 30-1, two or more biases may be set.

The first product-sum operation circuit 30-1 outputs an output value that is a binarized value of a value obtained by adding a product-sum operation value calculated by product-sum operation of M input values and M weights, and a predetermined number of biases. More specifically, for example, the first product-sum operation circuit 30-1 executes the operation of the following Formula (1).

$$y = f ( μ ) \qquad ( 1 )$$

$$μ = ( {\sum }_{i}^{M} {x}_{i} {w}_{i} ) + b$$

In Formula (1), y represents an output value of the first product-sum operation circuit 30-1. x₁ represents an i-th input value (i is an integer of 1 or greater and M or less) among the M input values. w₁ represents a weight to be multiplied by the i-th input value among the M weights. In Formula (1), μ represents a value obtained by adding a product-sum operation value calculated by product-sum operation of M input values and M weights, and a predetermined number of biases. In Formula (1), f(μ) represents a function that binarizes a value μ in parentheses with a predetermined threshold.

Formula (1) indicates an example in which one bias is set for the first product-sum operation circuit 30-1. In a case where a plurality of biases is set, μ in Formula (1) includes a term that adds a plurality of b instead of a term that adds one b.

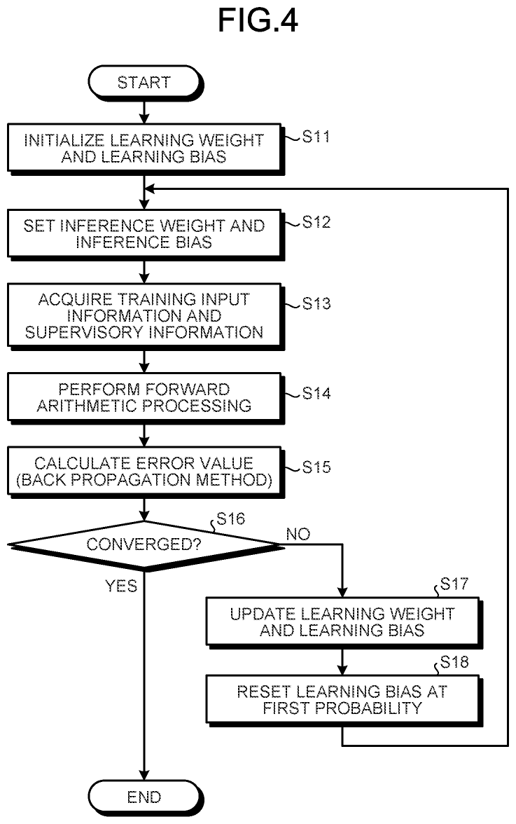

FIG. 4 is a flowchart illustrating a flow of processing at the time of learning of the neural network device 10 according to the embodiment. The neural network device 10 executes processing in the flow illustrated in FIG. 4 at the time of learning.

First, in S11, the learning control circuit 26 initializes a plurality of learning weights stored in the learning weight storage circuit 22 and a plurality of learning biases stored in the learning bias storage circuit 24. For example, the learning control circuit 26 sets each of the plurality of learning weights and each of the plurality of learning biases to random values, which are represented with 10-bit precision.

Subsequently, in S12, the learning control circuit 26 sets a plurality of weights (each weight is represented in binary) in the inference weight storage circuit 14. Along with this, the learning control circuit 26 sets a plurality of biases (each bias is represented in ternary) in the inference bias storage circuit 16. More specifically, the learning control circuit 26 controls the inference weight storage circuit 14 to transfer the plurality of weights obtained by binarizing each of the plurality of learning weights stored in the learning weight storage circuit 22. In addition, the learning control circuit 26 controls the inference bias storage circuit 16 to transfer the plurality of biases obtained by ternarizing each of the plurality of learning biases stored in the learning bias storage circuit 24.

Subsequently, in S13, the learning control circuit 26 acquires a pair of training input information representing the training arithmetic input value and the supervisory information representing correct arithmetic result values. Note that, in S13, the learning control circuit 26 may acquire a data set including a plurality of pieces of training input information and supervisory information.

Subsequently, in S14, the learning control circuit 26 gives the training input information to the arithmetic circuit 12, and controls the arithmetic circuit 12 to execute forward arithmetic processing according to the neural network using the plurality of weights stored in the inference weight storage circuit 14 and the plurality of biases stored in the inference bias storage circuit 16.

Subsequently, in S15, the learning control circuit 26 calculates the error value of each of the plurality of weights and the error value of each of the plurality of biases by applying back propagation of the error information between the operation result of the arithmetic processing in S14 and the corresponding supervisory information, to the neural network. That is, the learning control circuit 26 calculates an error value of each of the plurality of weights and an error value of each of the plurality of biases by using the back propagation method (i.e. the method of backward propagation of errors). When the data set including the plurality of pieces of training input information has been acquired in S13, the learning control circuit 26 executes the processes of S14 and S15 for each of the plurality of pieces of training input information.

Subsequently, in S16, the learning control circuit 26 determines whether learning has converged. For example, the learning control circuit 26 calculates an integral value by totaling error values of a plurality of weights and a plurality of biases, and determines that learning has converged when the calculated integral value becomes 0 or a predetermined value or less. Note that, in a case where the data set including the plurality of pieces of training input information is acquired in S13, the learning control circuit 26 calculates an integral value by totaling all of the plurality of error values calculated for the plurality of pieces of training input information, and then determines that the learning has converged when the calculated integral value becomes 0, or a predetermined value or less.

When the learning has converged (Yes in S16), the learning control circuit 26 ends the present flow. When the learning has not converged (No in S16), the learning control circuit 26 proceeds to the process of S17.

Subsequently, in S17, the learning control circuit 26 updates each of the plurality of learning weights stored in the learning weight storage circuit 22 based on the error value of the corresponding weight. For example, the learning control circuit 26 adds an error value of a corresponding weight to each of the plurality of learning weights stored in the learning weight storage circuit 22. Furthermore, the learning control circuit 26 updates each of the plurality of learning biases stored in the learning bias storage circuit 24 based on the error value of the corresponding bias. For example, the learning control circuit 26 adds the error value of the corresponding bias to each of the plurality of learning biases stored in the learning bias storage circuit 24.

Subsequently, in S18, the bias reset circuit 28 selects a bias to be reset with a preset first probability among the plurality of biases. The bias reset circuit 28 then resets the learning bias corresponding to the selected bias to a value to be converted into a median in the ternary. For example, the bias reset circuit 28 resets the learning bias corresponding to the selected bias to a value to be converted to 0 when represented in ternary.

After completion of the process of S18, the learning control circuit 26 returns the process to S12 and executes the next learning process.

By executing the above process, the learning control circuit 26 can repeat the learning process of updating each of the plurality of weights and each of the plurality of biases a plurality of times based on an operation result of arithmetic processing according to the neural network by the arithmetic circuit 12. Furthermore, in each of the learning processes repeated a plurality of times, the bias reset circuit 28 can reset a bias selected with a preset first probability, among the plurality of biases, to the median in the ternary.

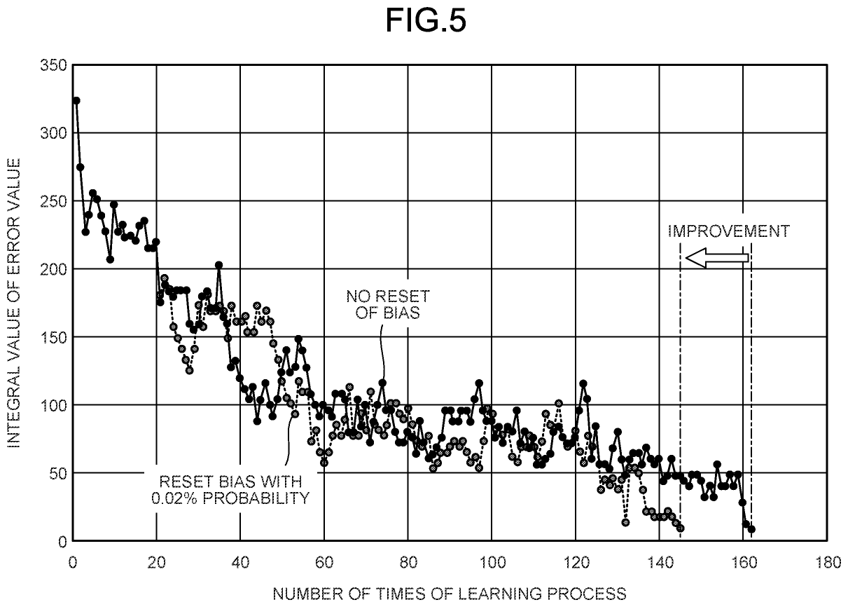

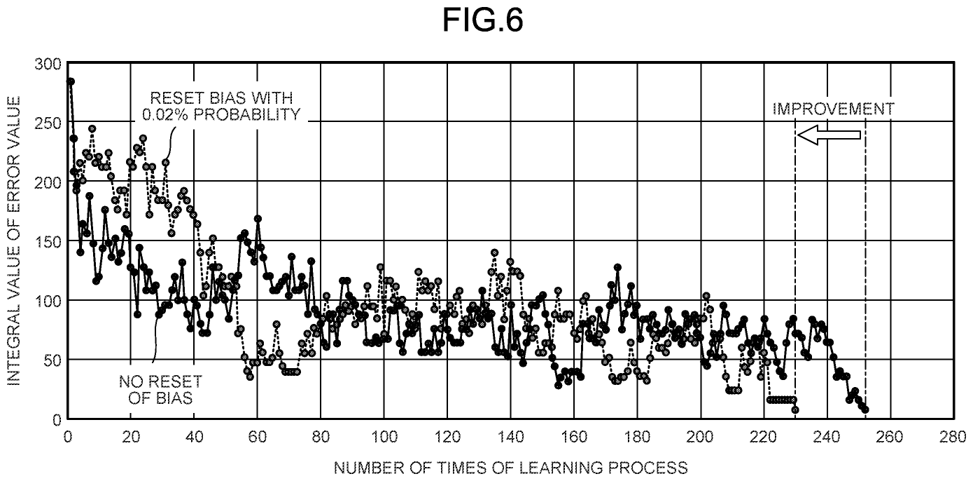

FIGS. 5 and 6 are diagrams illustrating simulation results representing integral values of error values with respect to the number of times of the learning process in a case where the bias is not reset and in a case where the bias is reset. In FIGS. 5 and 6, the horizontal axis represents the number of times of learning process, and the vertical axis represents the integral value of the error value.

The target neural network used in the simulations of FIGS. 5 and 6 has a three-layer configuration, which includes an input layer, an intermediate layer, and an output layer.

The input layer acquires 16 arithmetic input values. Each of the 16 arithmetic input values can be either −1 or +1. However, the input layer outputs the arithmetic input value as it is. Accordingly, the target neural network has a substantially two-layer configuration.

The intermediate layer has 31 nodes. Each of the 31 nodes in the intermediate layer acquires 16 values output from the input layer, as 16 input values. Each of the 31 nodes in the intermediate layer calculates a multiplied value obtained by multiplying each of the 16 input values by the corresponding weight, and further outputs an intermediate value obtained by adding the 16 multiplied values and the bias corresponding to the node. Each of the weights can be −1 or +1. Each of the biases can be −1, 0, or +1.

Furthermore, each of the 31 nodes outputs an output value obtained by binarizing the intermediate value. Each of the 31 nodes sets the output value to +1 when the intermediate value is 0 or greater, and sets the output value to −1 when the intermediate value is less than 0.

The output layer has 16 nodes. Each of the 16 nodes of the output layer acquires 31 values output from the intermediate layer, as 31 input values. Each of the 31 nodes in the output layer calculates a multiplied value obtained by multiplying each of the 31 input values by the corresponding weight, and further outputs an intermediate value obtained by adding the 31 multiplied values and the bias corresponding to the node. Each of the 31 nodes of the output layer is the same as the node included in the intermediate layer in other respects. Subsequently, the output layer outputs the values output from the 16 nodes as 16 arithmetic result values.

Training of the target neural network uses a plurality of learning weights corresponding one-to-one to a plurality of weights used in a target neural network and uses a plurality of learning biases corresponding one-to-one to a plurality of biases. Each of the plurality of learning weights and each of the plurality of learning biases are signed 10-bit precision values representing a range of −1 to +1, and are expressed by floating points.

The training of the target neural network is performed by updating the plurality of learning weights and the plurality of learning biases according to the back propagation method. In the learning, each of the plurality of weights is set to a value obtained by binarizing a corresponding learning weight among the plurality of learning weights. Furthermore, in the learning, each of the plurality of biases is set to a value obtained by ternarizing a corresponding learning bias among the plurality of learning biases.

In the training of the target neural network, the error value of each of the plurality of learning weights and the error value of each of the plurality of learning biases are calculated according to the back propagation method, and then, the calculated error value is added to the corresponding learning weight or the corresponding learning bias. The differential function used in the learning is a differential function of a hyperbolic tangent. The error value is represented with the same precision as the learning weight and the learning bias.

When the target neural network as described above is trained by using the learning method as described above, the learning converges with less learning times when the bias is reset than when the bias is not reset as illustrated in FIGS. 5 and 6. FIGS. 5 and 6 illustrate an example in which the bias is reset with a probability of 0.02%.

Note that a difference between FIGS. 5 and 6 is a difference in initial values set for a plurality of weights and a plurality of biases. Other conditions and settings are the same in FIGS. 5 and 6.

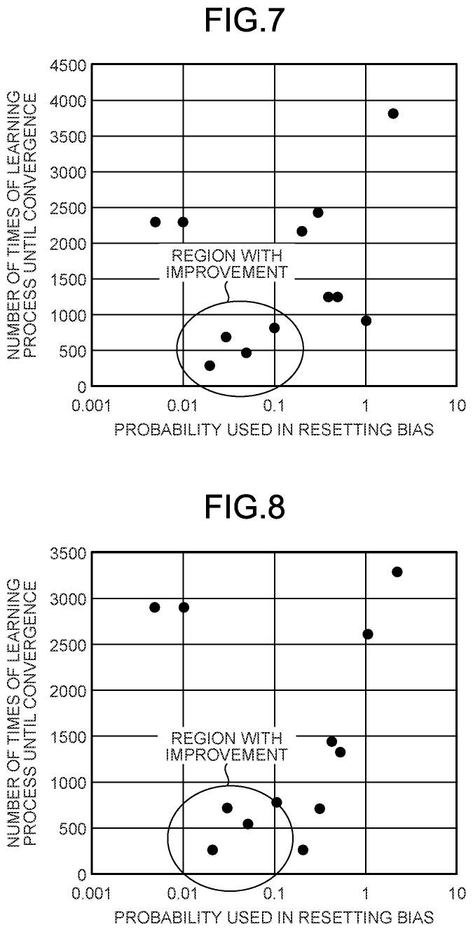

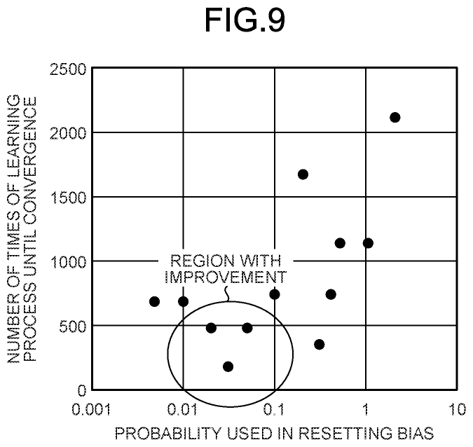

FIGS. 7, 8, and 9 are diagrams illustrating simulation results indicating the number of times of the learning process until convergence with respect to the first probability (probability used in resetting the bias). The target neural network and the learning method are the same as those in FIGS. 5 and 6.

A difference between FIGS. 7, 8, and 9 is a difference in initial values set for a plurality of weights and a plurality of biases. It is observed that the number of times of the learning process until convergence is decreased in the region in the ellipse in each of FIGS. 7, 8, and 9. Consequently, in the simulated target neural network and learning method, it is preferable to set the first probability to be in a range of 0.01% or greater and 0.1% or less.

As described above, the neural network device 10 according to the present embodiment resets the bias randomly selected with the preset first probability among the plurality of biases to the median in the ternary in each of the learning processes. With this operation, it is possible, with the neural network device 10 according to the present embodiment, to achieve high-precision learning with less learning times.

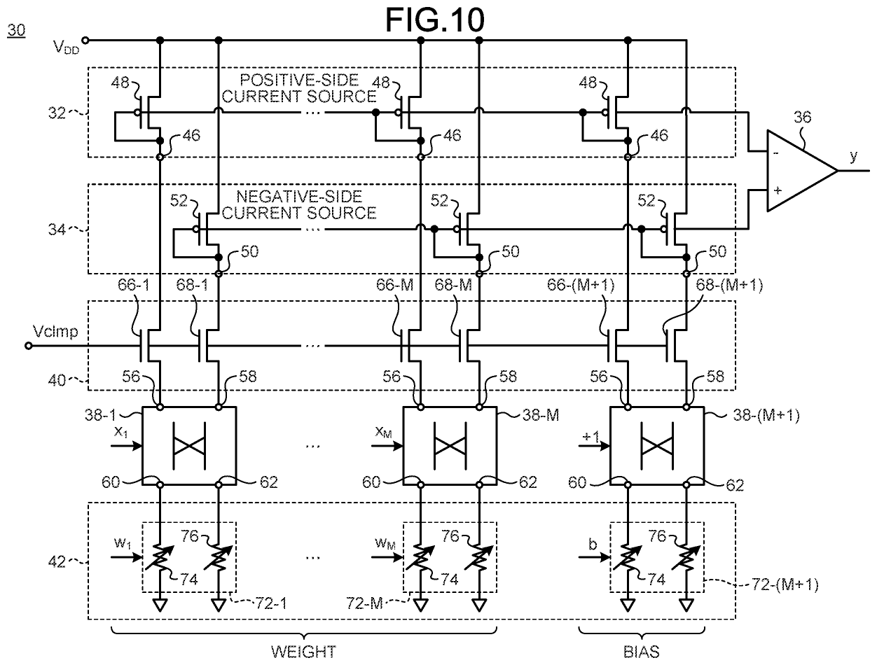

FIG. 10 is a diagram illustrating a hardware configuration of the product-sum operation circuit 30. The product-sum operation circuit 30 includes a positive-side current source 32, a negative-side current source 34, a comparison unit 36, (M+1) cross switches 38, a clamp circuit 40, and a storage circuit 42.

The positive-side current source 32 has a positive side terminal 46. The positive-side current source 32 outputs a current from the positive side terminal 46. Furthermore, the positive-side current source 32 outputs a first voltage corresponding to the value being 1/B (B is an integer of 2 or greater) of the current output from the positive side terminal 46. The positive-side current source 32 is an example of a positive-side circuit. The first voltage is an example of a positive-side signal.

For example, the positive-side current source 32 outputs a first voltage proportional to the value being 1/B of the current output from the positive side terminal 46. In the present embodiment, B=(M+1). However, B does not have to be the same as (M+1). Note that FIG. 10 illustrates a plurality of positive side terminals 46. However, the plurality of positive side terminals 46 illustrated in FIG. 10 is electrically connected.

For example, the positive-side current source 32 includes B first FETs 48. Each of the B first FETs 48 is a field effect transistor having the same characteristics. In the present embodiment, each of the B first FETs 48 is a pMOS transistor having the same characteristics.

The B first FETs 48 have a gate connected in common, a source connected to a second reference potential, and a drain connected to the gate and the positive side terminal 46. The second reference potential is a positive-side power supply voltage (V_{DD}), for example. That is, each of the B first FETs 48 operates as a diode-connected transistor, in which the source is connected to the second reference potential (for example, V_{DD}), and the gate and drain are connected to the positive side terminal 46. In addition, the positive-side current source 32 outputs the voltage of the positive side terminal 46 (voltage of the gate of the first FET 48) as the first voltage.

The positive-side current source 32 configured like this generates a positive-side signal representing the absolute value of the value obtained by totaling the positive value groups out of the M multiplied values generated by multiplying each of the M weights by the corresponding input value of the M input values, and a predetermined number of biases.

The negative-side current source 34 has a negative side terminal 50. The negative-side current source 34 outputs a current from the negative side terminal 50. Furthermore, the negative-side current source 34 outputs a second voltage corresponding to the value being 1/B of the current output from the negative side terminal 50. The negative-side current source 34 is an example of a negative-side circuit. The second voltage is an example of a negative-side signal.

For example, the negative-side current source 34 outputs a second voltage proportional to the value being 1/B of the current output from the negative side terminal 50. Note that FIG. 10 illustrates a plurality of negative side terminals 50. However, the plurality of negative side terminals 50 is electrically connected.

For example, the negative-side current source 34 includes B second FETs 52. Each of the B second FETs 52 is a field effect transistor having the same characteristics as the first FET 48. In the present embodiment, each of the B second FETs 52 is a pMOS transistor having the same characteristics as the first FET 48.

The B second FETs 52 have a gate connected in common, a source connected to a second reference potential, and a drain connected to the gate and the negative side terminal 50. That is, each of the B second FETs 52 operates as a diode-connected transistor, in which the source is connected to the second reference potential (for example, V_{DD}), and the gate and drain are connected to the negative side terminal 50. In addition, the negative-side current source 34 outputs the voltage of the negative side terminal 50 (voltage of the gate of the second FET 52) as the second voltage.

The negative-side current source 34 like this generates a negative-side signal representing the absolute value of the value obtained by totaling the negative value groups out of the M multiplied values generated by multiplying each of the M weights by the corresponding input value of the M input values, and a predetermined number of biases.

The comparison unit 36 is an example of a comparator circuit. The comparison unit 36 compares the magnitude of the first voltage output from the positive-side current source 32 and the second voltage output from the negative-side current source 34. Subsequently, the comparison unit 36 outputs an output value (y) corresponding to the comparison result between the first voltage and the second voltage. The comparison unit 36 outputs an output value of the first logic (for example, −1) when the first voltage is smaller than the second voltage, and outputs an output value of the second logic (for example, +1) when the first voltage is equal to or greater than the second voltage. The comparison unit 36 may output an output value of the second logic (for example, +1) when the first voltage is smaller than the second voltage, and may output an output value of the first logic (for example, −1) when the first voltage is equal to or greater than the second voltage.

The (M+1) cross switches 38 include M cross switches 38-1 to 38-M corresponding to the M input values, and one cross switch 38-(M+1) corresponding to one bias. In the present embodiment, the product-sum operation circuit 30 includes a first cross switch 38-1 to an M-th cross switch 38-M as M cross switches 38 corresponding to the M input values. For example, the first cross switch 38-1 corresponds to the first input value (x₁), the second cross switch 38-2 corresponds to the second input value (x₂), and the M-th cross switch 38-M corresponds to the M-th input value (x_{M}). In the present embodiment, the product-sum operation circuit 30 includes an (M+1)-th cross switch 38-(M+1) as the cross switch 38 corresponding to the bias.

Each of the (M+1) cross switches 38 has a positive inflow terminal 56, a negative inflow terminal 58, a first terminal 60, and a second terminal 62.

Each of the (M+1) cross switches 38 connects the first terminal 60 to either one of the positive inflow terminal 56 or the negative inflow terminal 58. Furthermore, each of the (M+1) cross switches 38 connects the second terminal 62 to the other of the positive inflow terminal 56 and the negative inflow terminal 58 to which the first terminal 60 is not connected. Each of the M cross switches 38 corresponding to the M input values performs switching as to whether the first terminal 60 and the second terminal 62 are to be connected to which of the positive inflow terminal 56 or the negative inflow terminal 58 depending on the value of the corresponding input value. The cross switch 38 corresponding to the bias connects the first terminal 60 and the second terminal 62 to either the positive inflow terminal 56 or the negative inflow terminal 58 depending on a value (for example, +1) fixed in advance.

The clamp circuit 40 includes (M+1) positive FET switches 66 corresponding to the (M+1) cross switches 38. In the present embodiment, the clamp circuit 40 includes a first positive FET switch 66-1 to an (M+1)-th positive FET switch 66-(M+1) as the (M+1) positive FET switches 66. For example, the first positive FET switch 66-1 corresponds to the first cross switch 38-1, the second positive FET switch 66-2 corresponds to the second cross switch 38-2, and the (M+1) positive FET switch 66-M corresponds to the (M+1)-th cross switch 38-(M+1).

Each of the (M+1) positive FET switches 66 has a configuration in which the gate is connected to a clamp potential (V_{clmp}), the source is connected to the positive side terminal 46, and the drain is connected to the corresponding positive inflow terminal 56 of the cross switch 38. Each of the (M+1) positive FET switches 66 is turned on between the source and the drain during operation. Therefore, the positive inflow terminal 56 of each of the (M+1) cross switches 38 is connected to the positive side terminal 46 of the positive-side current source 32 during operation, and the voltage is fixed to the clamp potential (V_{clmp}).

The clamp circuit 40 further includes (M+1) negative FET switches 68 each of which corresponding to each of the (M+1) cross switches 38. In the present embodiment, the clamp circuit 40 includes a first negative FET switch 68-1 to an (M+1)-th negative FET switch 68-(M+1) as the (M+1) negative FET switches 68. For example, the first negative FET switch 68-1 corresponds to the first cross switch 38-1, the second negative FET switch 68-2 corresponds to the second cross switch 38-2, and the (M+1)-th negative FET switch 68-(M+1) corresponds to the (M+1)-th cross switch 38-(M+1).

Each of the (M+1) negative FET switches 68 has a configuration in which the gate is connected to a clamp potential (V_{clmp}), the source is connected to the negative side terminal 50, and the drain is connected to the corresponding negative inflow terminal 58 of the cross switch 38. Each of the (M+1) negative FET switches 68 is turned on between the source and the drain during operation. Therefore, the negative inflow terminal 58 of each of the (M+1) cross switches 38 is connected to the negative side terminal 50 of the negative-side current source 34 during operation, and the voltage is fixed to the clamp potential (V_{clmp}).

The storage circuit 42 includes (M+1) cells 72. The (M+1) cells 72 include M cells 72 corresponding to the M weights and one cell 72 corresponding to one bias. In the present embodiment, the storage circuit 42 includes a first cell 72-1 to an M-th cell 72-M as the M cells 72 corresponding to the M weights. For example, the first cell 72-1 corresponds to the first weight (w₁), the second cell 72-2 corresponds to the second weight (w₂), and the M-th cell 72-M corresponds to the M-th weight (w_{M}). The first weight (w₁) corresponds to the first input value (x₁), the second weight (w₂) corresponds to the second input value (x₂), and the M-th weight (w_{M}) corresponds to the M-th input value (x_{M}). Accordingly, for example, the first cell 72-1 corresponds to the first cross switch 38-1, the second cell 72-2 corresponds to the second cross switch 38-2, and the M-th cell 72-M corresponds to the M-th cross switch 38-M. In the present embodiment, the storage circuit 42 includes a (M+1)-th cell 72-(M+1) as the cell 72 corresponding to the bias. Accordingly, the (M+1)-th cell 72-(M+1) corresponds to the (M+1)-th cell 72-(M+1).

Each of the (M+1) cells 72 includes a first resistor 74 and a second resistor 76. The first resistor 74 is connected at one end to the first terminal 60 of the corresponding cross switch 38 while being connected at the other end to the first reference potential. The first reference potential is, for example, ground. The second resistor 76 is connected at one end to the second terminal 62 of the corresponding cross switch 38 while being connected at the other end to the first reference potential.

Each of the first resistor 74 and the second resistor 76 is a memristor, for example. Furthermore, the first resistor 74 and the second resistor 76 may be other types of variable resistors. The magnitude relationship of the resistance values of the first resistor 74 and the second resistor 76 is switched depending on the corresponding weight or bias. For example, the storage circuit 42 receives M weights prior to receiving M input values. Then, the storage circuit 42 sets the magnitude relationship between the resistance values of the first resistor 74 and the second resistor 76 included in the corresponding cell 72 in accordance with each of the received M weights. In addition, when the bias is the median in the ternary (for example, when the bias is 0), the storage circuit 42 sets the first resistor 74 and the second resistor 76 to the same resistance value.

For example, in each of the (M+1) cells 72, when the corresponding weight or bias is +1, the first resistor 74 will be set to a first resistance value, and the second resistor 76 will be set to a second resistance value different from the first resistance value. Furthermore, in each of the (M+1) cells 72, when the corresponding weight or bias is −1, the first resistor 74 will be set to the second resistance value, and the second resistor 76 will be set to the first resistance value. In addition, when the bias is the median in the ternary (for example, when the bias is 0), the first resistor 74 and the second resistor 76 are set to the same resistance value in the (M+1)-th cell 72-(M+1).

Furthermore, in each of the (M+1) cells 72, one of the first resistor 74 or the second resistor 76 may be a fixed resistor and the other may be a variable resistor. In each of the (M+1) cells 72, both the first resistor 74 and the second resistor 76 may be variable resistors. In this case, in each of the (M+1) cells 72, the resistance value of the variable resistor is changed so that the positive/negative of the resistance difference between the first resistor 74 and the second resistor 76 is inverted depending on whether the corresponding weight is +1 or −1. In this case, in the (M+1)-th cell 72-(M+1), when the bias is 0, the resistance value of the variable resistor is changed such that the resistance difference between the first resistor 74 and the second resistor 76 becomes 0.

In addition, each of the M cross switches 38 corresponding to the M input values out of the (M+1) cross switches 38 performs switching whether to use the straight connection or reverse connection on the first terminal 60 and the second terminal 62 with the positive side terminal 46 (positive inflow terminal 56) and the negative side terminal 50 (negative inflow terminal 58) in accordance with the corresponding input values.

For example, when using straight connection, each of the M cross switches 38 corresponding to the M input values connects the first terminal 60 with the positive side terminal 46 (positive inflow terminal 56) and connects the second terminal 62 with the negative side terminal 50 (negative inflow terminal 58). Furthermore, when using reverse connection, each of the M cross switches 38 corresponding to the M input values connects the first terminal 60 with the negative side terminal 50 (negative inflow terminal 58) and connects the second terminal 62 with the positive side terminal 46 (positive inflow terminal 56).

For example, each of the M cross switches 38 corresponding to the M input values uses the straight connection when the corresponding input value is +1 and uses the reverse connection when the corresponding input value is −1. Instead, each of the M cross switches 38 corresponding to the M input values may use the reverse connection when the corresponding input value is +1 and may use the straight connection when the corresponding input value is −1.

The cross switch 38 corresponding to the bias is fixed to either straight connection or reverse connection. For example, +1 is fixedly input to the cross switch 38 corresponding to the bias, and is fixed to the straight connection.

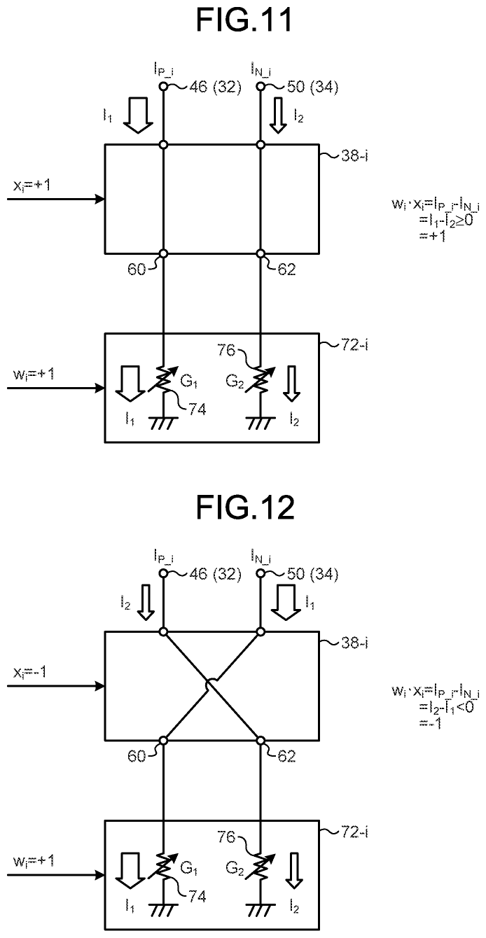

FIG. 11 is a diagram for explaining arithmetic operation of the product-sum operation circuit 30 when wᵢ=+1 and xᵢ=+1. When the i-th weight (wᵢ) is +1, the first resistor 74 of the i-th cell 72-i is set to a first conductance (G₁=1/R₁). When the i-th weight (wᵢ) is +1, the second resistor 76 of the i-th cell 72-i is set to a second conductance (G₂=1/R₂). In this case, the current of a first current value (I₁) flows through the first resistor 74. Furthermore, a current having a second current value (I₂) flows through the second resistor 76. Note that G₁>G₂. Therefore, I₁>I₂ is established.

Furthermore, when the i-th input value (xᵢ) is +1, the i-th cross switch 38-i uses the straight connection. Therefore, the positive side terminal 46 of the positive-side current source 32 supplies current to the first resistor 74 of the i-th cell 72-i. Furthermore, the negative side terminal 50 of the negative-side current source 34 supplies current to the second resistor 76 of the i-th cell 72-i.

Here, the product-sum operation circuit 30 represents a calculation result of a value (wᵢ·xᵢ) obtained by multiplying the i-th weight (wᵢ) by the i-th input value (xᵢ) by using a current difference (I_{P_i}−I_{N_i}) between the current (I_{P_i}) flowing from the positive side terminal 46 to the i-th cell 72-i and the current (I_{N_i}) flowing from the negative side terminal 50 to the i-th cell 72-i.

Therefore, in the example of FIG. 11, I_{P_i}=and I_{N_i}=I₂ are established, and the current difference (I_{P_i}−I_{N_i}) will be a positive value. Therefore, when wᵢ=+1 and xᵢ=+1, the product-sum operation circuit 30 can calculate +1 as the value (wᵢ·xᵢ) obtained by multiplying the i-th weight (wᵢ) and the i-th input value (xᵢ).

FIG. 12 is a diagram for explaining arithmetic operation of the product-sum operation circuit 30 when wᵢ=+1 and xᵢ=−1. When the i-th weight (wᵢ) is +1, the first resistor 74 of the i-th cell 72-i is set to a first conductance (G₁). When the i-th weight (wᵢ) is +1, the second resistor 76 of the i-th cell 72-i is set to a second conductance (G₂). In this case, the current of a first current value (I₁) flows through the first resistor 74. Furthermore, a current having a second current value (I₂) flows through the second resistor 76.

When the i-th input value (xᵢ) is −1, the i-th cross switch 38-i uses the reverse connection. Therefore, the positive side terminal 46 of the positive-side current source 32 supplies current to the second resistor 76 of the i-th cell 72-i. Furthermore, the negative side terminal 50 of the negative-side current source 34 supplies current to the first resistor 74 of the i-th cell 72-i.

Therefore, in the example of FIG. 12, I_{P_i}=I₂ and I_{N_i}=I₁ are established, and the current difference (I_{P_i}−I_{N_i}) will be a negative value. Therefore, when wᵢ=+1 and xᵢ=−1, the product-sum operation circuit 30 can calculate −1 as the value (wᵢ·xᵢ) obtained by multiplying the i-th weight (wᵢ) and the i-th input value (xᵢ).

Even when the bias (b) is −1 and the value input to the cross switch 38 is fixed at +1, the product-sum operation circuit 30 can similarly calculate −1 as a value (b) obtained by multiplying the bias (b) by the fixed input value (+1).

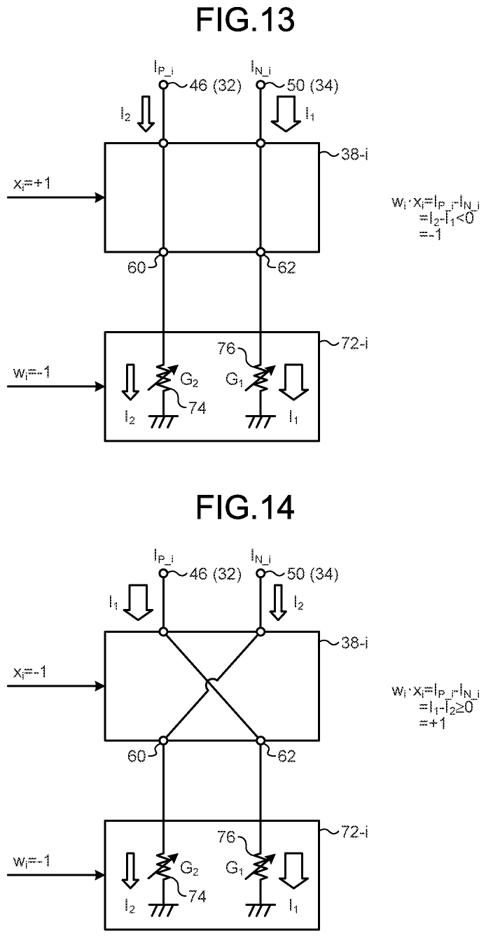

FIG. 13 is a diagram for explaining arithmetic operation of the product-sum operation circuit 30 when wᵢ=−1 and xᵢ=+1. When the i-th weight (wᵢ) is −1, the first resistor 74 of the i-th cell 72-i is set to the second conductance (G₂). When the i-th weight (wᵢ) is −1, the second resistor 76 of the i-th cell 72-i is set to the first conductance (G₁). Therefore, in this case, the current of the second current value (I₂) flows through the first resistor 74. Furthermore, the current of the first current value (I₁) flows through the second resistor 76.

Furthermore, when the i-th input value (xᵢ) is +1, the i-th cross switch 38-i uses the straight connection. Therefore, the positive side terminal 46 of the positive-side current source 32 supplies current to the first resistor 74 of the i-th cell 72-i. Furthermore, the negative side terminal 50 of the negative-side current source 34 supplies current to the second resistor 76 of the i-th cell 72-i.

Therefore, in the example of FIG. 13, I_{P_i}=I₂ and I_{N_i}=I₁ are established, and the current difference (I_{P_i}−I_{N_i}) will be a negative value. Therefore, when wᵢ=−1 and xᵢ=+1, the product-sum operation circuit 30 can calculate −1 as the value (wᵢ·xᵢ) obtained by multiplying the i-th weight (wᵢ) and the i-th input value (xᵢ).

FIG. 14 is a diagram for explaining arithmetic operation of the product-sum operation circuit 30 when wᵢ=−1 and xᵢ=−1. When the i-th weight (wᵢ) is −1, the first resistor 74 of the i-th cell 72-i is set to the second conductance (G₂). When the i-th weight (wᵢ) is −1, the second resistor 76 of the i-th cell 72-i is set to the first conductance (G₁). Therefore, in this case, the current of the second current value (I₂) flows through the first resistor 74. Furthermore, the current of the first current value (I₁) flows through the second resistor 76.

When the i-th input value (xᵢ) is −1, the i-th cross switch 38-i uses the reverse connection. Therefore, the positive side terminal 46 of the positive-side current source 32 supplies current to the second resistor 76 of the i-th cell 72-i. Furthermore, the negative side terminal 50 of the negative-side current source 34 supplies current to the first resistor 74 of the i-th cell 72-i.

Therefore, in the example of FIG. 14, I_{P_i}=I₁ and I_{N_i}=I₂ are established, and the current difference (I_{P_i}−I_{N_i}) will be a positive value. Therefore, when wᵢ=−1 and xᵢ=−1, the product-sum operation circuit 30 can calculate +1 as the value (wᵢ·xᵢ) obtained by multiplying the i-th weight (wᵢ) and the i-th input value (xᵢ).

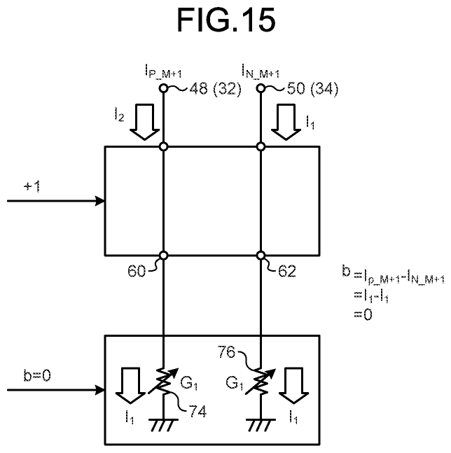

FIG. 15 is a diagram for explaining arithmetic operation of the product-sum operation circuit 30 when b=0. When the bias (b) is 0, the first resistor 74 of the (M+1)-th cell 72-(M+1) is set to the first conductance (G₁). When the bias (b) is 0, the second resistor 76 of the (M+1)-th cell 72-(M+1) is set to the first conductance (G₁). Therefore, in this case, the current of a first current value (I₁) flows through the first resistor 74. Furthermore, the current of the first current value (I₁) flows through the second resistor 76.

The (M+1)-th cross switch 38-(M+1) has an input of a fixed value of +1 and is connected through straight connection. Therefore, the positive side terminal 46 of the positive-side current source 32 supplies current to the first resistor 74 of the (M+1)-th cell 72-(M+1). Furthermore, the negative side terminal 50 of the negative-side current source 34 supplies current to the second resistor 76 of the (M+1)-th cell 72-(M+1).

Therefore, in the example of FIG. 15, I_{P_(M+1)}=I₁, and I_{N_(M+1)}=I₁ are established, and the current difference (I_{P_(M+1)}−I_{N_(M+1)}) becomes 0. Therefore, when b=0, the product-sum operation circuit 30 can calculate 0 as the bias (b).

When the bias (b) is 0, the first resistor 74 and the second resistor 76 of the (M+1)-th cell 72-(M+1) may be set to the second conductance (G₂). In this case, the current of the second current value (I₂) flows through the first resistor 74 and the second resistor 76. Also in this case, the current difference (I_{P_(M+1)}−I_{N_(M+1)}) becomes 0, and the product-sum operation circuit 30 can calculate 0 as the bias (b).

As described above, the difference (I_{P_i}−I_{N_i}) between the current (I_{P_i}) output from the positive side terminal 46 to the i-th cell 72-i and the current (I_{N_i}) output from the negative side terminal 50 to the i-th cell 72-i represents the multiplied value (wᵢ·xᵢ) of the i-th weight (wᵢ) and the i-th input value (xᵢ). Moreover, the difference (I_{P_(M+1)}−I_{N_(M+1)}) between the current (I_{P_(M+1)}) output from the positive side terminal 46 to the (M+1)-th cell 72-(M+1) and the current (I_{N_(M+1)}) output from the negative side terminal 50 to the (M+1)-th cell 72-(M+1) represents the bias (b).

Accordingly, the difference value {(I_{P_1}+I_{P_2}+ . . . +I_{P_(M+1)})−(I_{N_1}+I_{N_2}+ . . . +I_{N_(M+1)})} between the total current (I_{P_1}+I_{P_2}+ . . . +I_{P_(M+1)}) output from the positive side terminal 46 of the positive-side current source 32 and the total current (I_{N_1}+I_{N_2}+ . . . +I_{N_(M+1)}) output from the negative side terminal 50 of the negative-side current source 34 represents a value obtained by addition of the result of product-sum operation (multiply-accumulation) of M input values and M weights, and the bias (b).

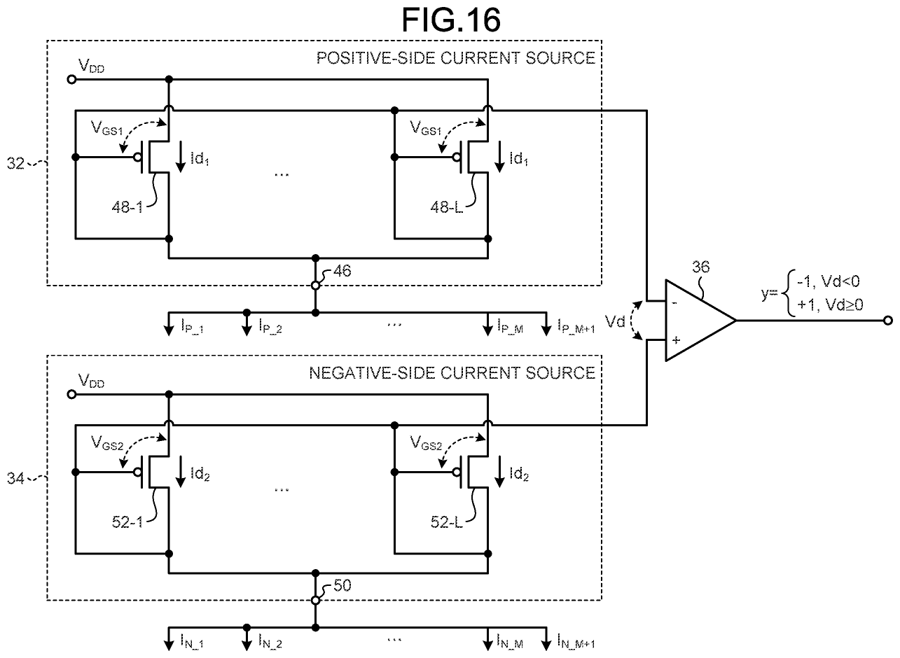

FIG. 16 is a diagram for explaining operations of the positive-side current source 32, the negative-side current source 34, and the comparison unit 36.

The positive-side current source 32 outputs the current of to the first cell 72-1. Furthermore, the positive-side current source 32 outputs the current of I_{P_2} to the second cell 72-2. In addition, the positive-side current source 32 outputs a current of I_{P_(M+1)} to the (M+1)-th cell 72-(M+1). Accordingly, the positive-side current source 32 outputs the current of I_{P_1}+I_{P_2}+ . . . +I_{P_(M+1)} from the positive side terminal 46. That is, the positive-side current source 32 outputs, from the positive side terminal 46, the current representing the absolute value of the value obtained by totaling the positive value groups out of the M multiplied values generated by multiplying each of the M weights by the corresponding input value of the M input values, and a predetermined number of biases.

Furthermore, the positive-side current source 32 includes B first FETs 48. The B first FETs 48 have the same characteristics and have the same connection relationship. Therefore, the B first FETs 48 carry a same drain current (Id₁).

The total drain current (Id₁) of the B first FETs 48 is B×Id₁. The drain current (Id₁) of the B first FETs 48 will be entirely supplied to the positive side terminal 46. Therefore, B×Id₁=(I_{P_1}+I_{P_2}+ . . . +I_{P_(M+1)}). That is, the drain current (Id₁) of each of the B first FETs 48 will be (I_{P_1}+I_{P_2}+ . . . +I_{P_(M+1)})/B.

The negative-side current source 34 outputs the current of I_{N_1} to the first cell 72-1. Furthermore, the negative-side current source 34 outputs the current of I_{N_2} to the second cell 72-2. In addition, the negative-side current source 34 outputs the current of I_{N_(M+1)} to the M-th cell 72-M. Accordingly, the negative-side current source 34 outputs the current of I_{N_1}+I_{N_2}+ . . . +I_{N_(M+1)} from the negative side terminal 50. That is, the negative-side current source 34 outputs, from the negative side terminal 50, the current representing the absolute value of the value obtained by totaling the negative value groups out of the M multiplied values generated by multiplying each of the M weights by the corresponding input value of the M input values, and a predetermined number of biases.

The negative-side current source 34 includes B second FETs 52. The B second FETs 52 have the same characteristics and have the same connection relationship. Therefore, the B second FETs 52 carry a same drain current (Id₂).

The total drain current (Id₂) of the B second FETs 52 is B×Id₂. The drain current (Id₂) of the B second FETs 52 will be entirely supplied to the negative side terminal 50. Therefore, B×Id₂=(I_{N_1}+I_{N_2}+ . . . +I_{N_(M+1)}). That is, the drain current (Id₂) of each of the B second FETs 52 will be (I_{N_1}+I_{N_2}+ . . . +I_{N_(M+1)})/B.

The positive-side current source 32 outputs the voltage generated at the positive side terminal 46 as the first voltage. The voltage generated at the positive side terminal 46 is a potential obtained by subtracting a gate-source voltage (V_{GS1}) of the first FET 48 from the second reference potential (for example, V_{DD}).

Meanwhile, the negative-side current source 34 outputs the voltage generated at the negative side terminal 50 as the second voltage. The voltage generated at the negative side terminal 50 is a potential obtained by subtracting a gate-source voltage (V_{GS2}) of the second FET 52 from the second reference potential (for example, V_{DD}).

The comparison unit 36 determines whether a difference (Vd) between the first voltage and the second voltage is less than 0, or 0 or greater. For example, the comparison unit 36 outputs the first logic (for example, −1) when the difference (Vd) between the first voltage and the second voltage is less than 0, and outputs the second logic (for example, +1) when the difference is 0 or greater.

Here, the difference (Vd) between the first voltage and the second voltage is equal to the voltage obtained by subtracting the gate-source voltage (V_{GS2}) of the second FET 52 from the gate-source voltage (V_{GS1}) of the first FET 48.

The gate-source voltage (V_{GS1}) of the first FET 48 is a value proportional to the drain current (Id₁) of the first FET 48. The gate-source voltage (V_{GS2}) of the second FET 52 is a value proportional to the drain current (Id₂) of the second FET 52. Furthermore, the first FET 48 and the second FET 52 have the same characteristics. Therefore, the difference (Vd) between the first voltage and the second voltage is proportional to the current obtained by subtracting the drain current ((I_{N_1}+I_{N_2}+ . . . +I_{N_(M+1)})/B) of the second FET 52 from the drain current ((I_{P_1}+I_{P_2}+ . . . +I_{P_(M+1)})/B) of the first FET 48.

From the above, the output value (y) represents whether the current obtained by subtracting the drain current ((I_{N_1}+I_{N_2}+ . . . +I_{N_(M+1)})/B) of the second FET 52 from the drain current ((I_{P_1}+I_{P_2}+ . . . +I_{P_(M+1)})/B) of the first FET 48 is less than 0, or 0 or greater.

Here, the number (B) of the first FETs 48 included in the positive-side current source 32 and the number (B) of the second FETs 52 included in the negative-side current source 34 are the same. Furthermore, the comparison unit 36 inverts the value with 0 as a threshold. The zero cross point of the current obtained by subtracting the drain current of the second FET 52 ((I_{N_1}+I_{N_2}+ . . . +I_{N_(M+1)})/B) from the drain current of the first FET 48 ((I_{P_1}+I_{P_2}+ . . . +I_{P_(M+1)})/B) is the same as the zero cross point of the current obtained by subtracting the total current (I_{N_1}+I_{N_2}+ . . . +I_{N_(M+1)}) output by the negative side terminal 50 from the total current (I_{P_1}+I_{P_2}+ . . . +I_{P_(M+1)}) output by the positive side terminal 46. Therefore, the output value (y) represents whether the current obtained by subtracting the total current (I_{N_1}+I_{N_2}+ . . . +I_{N_(M+1)}) output by the negative side terminal 50 from the total current (I_{P_1}+I_{P_2}+ . . . +I_{P_(M+1)}) output by the positive side terminal 46 is less than 0, or 0 or greater.

The difference (I_{P_i}−I_{N_i}) between the current (I_{P_i}) output from the positive side terminal 46 to the i-th cell 72-i and the current (I_{N_i}) output from the negative side terminal 50 to the i-th cell 72-i represents the multiplied value (wᵢ·xᵢ) of the i-th weight (wᵢ) and the i-th input value (xᵢ). Moreover, the difference (I_{P_(M+1)}−I_{N_(M+1)}) between the current (I_{P_(M+1)}) output from the positive side terminal 46 to the (M+1)-th cell 72-(M+1) and the current (I_{N_(M+1)}) output from the negative side terminal 50 to the (M+1)-th cell 72-(M+1) represents the bias (b). In addition, the current obtained by subtracting the total current (I_{N_1}+I_{N_2}+ . . . +I_{N_(M+1)}) output by the negative side terminal 50 from the total current (I_{P_1}+I_{P_2}+ . . . +I_{P_(M+1)}) output by the positive side terminal 46 represents a value obtained by adding the product-sum operation (multiply-accumulation) value of the M input values and M weights, and the bias (b).

Therefore, the output value (y) indicates whether the value obtained by adding a product-sum operation (multiply-accumulation) value of M input values and M weights, and the bias (b), is less than 0, or 0 or greater.

In this manner, the product-sum operation circuit 30 can execute, by using analog processing, arithmetic processing of adding the product-sum value of the M input values and the M weights, and the bias. Consequently, the product-sum operation circuit 30 can generate an output value obtained by binarizing the product-sum operation value.

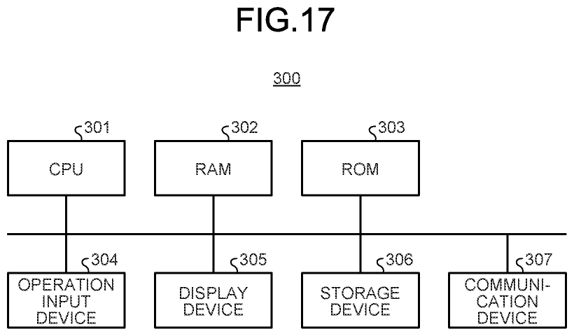

FIG. 17 is a diagram illustrating an example of a hardware configuration of the information processing device. The neural network device 10 can be implemented by an information processing device having a hardware configuration as illustrated in FIG. 17, for example, by operating in cooperation with a program. Furthermore, the neural network device 10 is not limited to the configuration illustrated in FIG. 17, and can be implemented by a server, a cloud implemented by a plurality of computers, or the like.

The information processing device includes a central processing unit (CPU) 301, random access memory (RAM) 302, read only memory (ROM) 303, an operation input device 304, a display device 305, a storage device 306, and a communication device 307. These components are interconnected by a bus. Note that the information processing device may have a configuration omitting the operation input device 304 and the display device 305.

The CPU 301 is a processor that executes arithmetic processing, control processing, and the like according to a program. The CPU 301 executes various processes in cooperation with a program stored in the ROM 303, the storage device 306, or the like, using a predetermined area of the RAM 302 as a work area.

The RAM 302 is memory such as synchronous dynamic random access memory (SDRAM). The RAM 302 functions as a work area of the CPU 301. The ROM 303 is memory that stores programs and various types of information in a non-rewritable manner.

The operation input device 304 is an input device such as a mouse and a keyboard. The operation input device 304 receives information operationally input from the user as an instruction signal, and outputs the instruction signal to the CPU 301.

The display device 305 is a display device such as a liquid crystal display (LCD). The display device 305 displays various types of information based on a display signal from the CPU 301.

The storage device 306 is a device that writes and reads data in and from a semiconductor storage medium such as flash memory, a magnetically or optically recordable storage medium, or the like. The storage device 306 writes and reads data in and from the storage medium under the control of the CPU 301. The communication device 307 communicates with an external device via a network under the control of the CPU 301.

The program for causing the information processing device to function as the neural network device 10 includes an arithmetic module, a learning control module, and a bias reset module. This program is developed and executed on the RAM 302 by the CPU 301 (processor), thereby causing the information processing device to function as an arithmetic unit, a learning control unit, and a bias resetting unit. The arithmetic unit executes the same processing as that performed by the arithmetic circuit 12. The learning control unit executes the same processing as that performed by the learning control circuit 26. The bias resetting unit executes the same processing as that performed by the bias reset circuit 28. Furthermore, this program is developed and executed on the RAM 302 by the CPU 301 (processor), thereby causing the RAM 302 or the storage device 306 to function as the inference weight storage circuit 14, the inference bias storage circuit 16, the learning weight storage circuit 22, and the learning bias storage circuit 24.

The program executed by the information processing device is recorded and provided in a computer-readable recording medium such as a CD-ROM, a flexible disk, a CD-R, a digital versatile disk (DVD) in a file in a computer-installable format or an executable format.

Moreover, the program executed by the information processing device may be stored on a computer connected to a network such as the Internet and provided by being downloaded via the network. Moreover, the program executed by the information processing device may be provided or distributed via a network such as the Internet. Moreover, the program executed by the information processing device may be provided by being incorporated in the ROM 303 or the like, in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A neural network device comprising:
an arithmetic circuit that executes arithmetic processing according to a neural network using a plurality of weights each represented by a value of a first resolution and a plurality of biases each represented by a value in ternary;
a learning control circuit that repeats a learning process of updating each of the plurality of weights and each of the plurality of biases a plurality of times based on a result of the arithmetic processing according to the neural network performed by the arithmetic circuit at a time of learning of the neural network; and
a bias reset circuit that resets a bias randomly selected with a preset first probability among the plurality of biases to a median in the ternary in each of the learning processes.

2. The neural network device according to claim 1, further comprising:
a learning weight storage circuit that stores therein a plurality of learning weights corresponding one-to-one to the plurality of weights and each represented by a second resolution higher than the first resolution; and
a learning bias storage circuit that stores therein a plurality of learning biases corresponding one-to-one to the plurality of biases and each represented by a third resolution higher than the ternary, wherein
each of the plurality of weights is a value obtained by converting a corresponding learning weight among the plurality of learning weights into a value of the first resolution, and
each of the plurality of biases is a value obtained by converting a corresponding learning bias among the plurality of learning biases into the ternary.

3. The neural network device according to claim 2, wherein in each of the learning processes, the learning control circuit performs:
calculating an error value for each of the plurality of weights and each of the plurality of biases by applying back propagation of error information between an operation result of the arithmetic processing performed by using the plurality of weights and the plurality of biases according to the neural network, and supervisory information, to the neural network;
adding the corresponding error value to each of the plurality of learning weights stored in the learning weight storage circuit; and
adding the corresponding error value to each of the plurality of learning biases stored in the learning bias storage circuit.

4. The neural network device according to claim 3, wherein
in each of the learning processes, the bias reset circuit resets a learning bias after the error value is added to a value to be converted into the median in the ternary for a bias randomly selected with the first probability among the plurality of biases.

5. The neural network device according to claim 1, wherein
each of the plurality of weights is represented in binary.

6. The neural network device according to claim 1, wherein
the arithmetic circuit acquires a plurality of arithmetic input values, gives the acquired plurality of arithmetic input values to the neural network, calculates one or more arithmetic result values, and outputs the calculated one or more arithmetic result values.

7. The neural network device according to claim 6, wherein
each of the plurality of arithmetic input values is represented in binary.

8. The neural network device according to claim 6, wherein
each of the one or more arithmetic result values is represented in binary.

9. The neural network device according to claim 6, wherein
the arithmetic circuit includes a plurality of product-sum operation circuits,
each of the plurality of product-sum operation circuits executes one of product-sum operation processes included in the neural network,
with respect to one product-sum operation circuit among the plurality of product-sum operation circuits,
M input values are input, M corresponding weights out of the plurality of weights and a corresponding predetermined number of biases out of the plurality of biases are set, M being an integer of 2 or greater, and
the one product-sum operation circuit outputs an output value obtained by adding a product-sum operation value calculated by product-sum operation on the M input values and the M weights, and the predetermined number of biases.

10. The neural network device according to claim 9, wherein
each of the M weights represents either −1 or +1,
each of the predetermined number of biases represents either one of −1, 0, or +1, and
each of the plurality of product-sum operation circuits comprises:
a positive-side circuit that generates a positive-side signal representing an absolute value of a value obtained by totaling a positive value group out of M multiplied values and the predetermined number of biases, the M multiplied values being generated by multiplying each of the M weights by a corresponding input value of the M input values;
a negative-side circuit that generates a negative-side signal representing an absolute value obtained by totaling a negative value group out of the M multiplied values and the predetermined number of biases; and
a comparator circuit that compares magnitude of the positive-side signal and the negative-side signal and outputs a comparison result as the output value.

11. An information processing device provided to achieve learning of a neural network using a plurality of weights each represented by a value of a first resolution and a plurality of biases each represented by a value in ternary, the information processing device comprising:
a processor, wherein
the processor performs:
repeating a learning process of updating each of the plurality of weights and each of the plurality of biases a plurality of times based on a result of arithmetic processing according to the neural network performed at a time of learning of the neural network; and
resetting a bias randomly selected with a preset first probability among the plurality of biases to a median in the ternary in each of the learning processes.

12. A computer program product having a computer readable medium including programmed instructions, wherein the instructions, when executed by a computer, cause the computer to function as:
an information processing device provided to achieve learning of a neural network using a plurality of weights each represented by a value of a first resolution and a plurality of biases each represented by a value in ternary,
the program causing the information processing device to perform:
repeating a learning process of updating each of the plurality of weights and each of the plurality of biases a plurality of times based on a result of arithmetic processing according to the neural network performed at a time of learning of the neural network; and
resetting a bias randomly selected with a preset first probability among the plurality of biases to a median in the ternary in each of the learning processes.
